(19) United States
(12) Patent Application Publication
(10) Pub. No.: US 2010/0309560 A1
(43) Pub. Date: Dec. 9, 2010

(54) Method for Forming Variable Focus Liquid Lenses in a Tubular Housing

(75) Inventors: Saman Dharmatilleke, Singapore (SG); Isabel Rodriguez Fernandez, Singapore (SG); Aik Hau Khaw, Singapore (SG)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Agency for Science, Technology and Research, Centros (SG)

(21) Appl. No.: 12/280,681

(22) PCT Filed: Feb. 24, 2006
(86) PCT No.: PCT/SG06/00036

§ 371 Date: Jan. 28, 2010

(51) Int. Cl. G02B 3/12; G02B 1/06

(52) U.S. Cl. 359/666

(57) ABSTRACT

The present invention provides a variable focus fluid lens wherein the focal length is controllable by changing the contact angle of a fluid meniscus. A liquid (20), such as water, is filled in a tubular housing (10) with an internal surface including adjacent hydrophilic (40) and hydrophobic (30) areas or regions, wherein the boundary between the hydrophilic and hydrophobic regions constrains the liquid (20) and presents a meniscus (50) having a curvature defined, in part, by the static contact angle at the boundary. When a control pressure is applied to the liquid (20), the curvature of the meniscus (50) varies as the contact angle of the liquid changes at the boundary.

### BACKGROUND OF THE INVENTION

The present invention relates generally to optical systems, and more particularly to variable focus fluid lenses.

Lasers, photoconductors, and other optical components are widely used in many optoelectronic applications such as, for example, optical communications systems and camera devices. Traditionally in such applications, manual positioning and tuning of a lens and its surrounding support structure is required to maintain focus of the image onto a detector and to receive light beams originating from different angular directions relative to the lens. However, devices that rely on such manual positioning can be slow and quite expensive.

To eliminate manual tuning, tunable microlenses were developed to achieve optimal optical coupling between an optical source and an optical signal receiver, such as a photodetector. The microlens acts to focus the optical signal onto its intended destination (e.g., the photodetector). In some cases the refractive index of these microlenses is automatically varied in order to change the focus characteristics of the microlens when the incidence of a light beam upon the microlens varies from its nominal, aligned incidence. Thus, the desired coupling is maintained between the microlens and the photodetector.

Tunable gradient index lenses have inherent limitations associated with the relatively small electro-optic coefficients found in the majority of electro-optic materials. This results in a small optical path modulation and, therefore, requires thick lenses or very high voltages to be employed. In addition, many electro-optic materials show strong birefringence that causes polarization dependence of the microlens, which distorts light with certain polarization.

Mechanically adjustable flexible lenses typically have a substantially wider range of tunability than the gradient index lenses. However, they require external actuation devices, such as micropumps, to operate. Integration of such actuation devices into optoelectronic packages involves substantial problems associated with their miniaturization and positioning. These become especially severe in the case where a two-dimensional array of tunable microlenses is required.

As an example, one weakness of the existing camera phones is that they use tiny, fixed-focus lenses, which have poor light-gathering capabilities, very limited focus range and limited resolution power. As a result, the image quality is rather low compared to conventional photo cameras. For future improvement, mobile phone cameras require compact means of focus adjustment.

Most variable focus lenses are limited to lenses actuated using the electro wetting effect (U.S. Pat. No. 6,538,823) and less successfully using liquid crystals. There are also a few publications of fluidic microlenses enclosed in thin polymer membranes (U.S. Pat. No. 6,188,525). These lenses were focused using an external actuator such as syringe pump.

Therefore it is desirable to provide systems and methods that overcome the above and other problems. In particular, low cost and compact microlenses that are free of mechanical optical alignment and have easy tunability with readily adjustable focus length are needed. Surprisingly, aspects of the present invention meets these and other needs.

### BRIEF SUMMARY OF THE INVENTION

The present invention provides a variable focus fluid lens wherein the focal length is controllable by changing the contact angle of a fluid meniscus. The meniscus of a fluid interface forms the optics of a lens and its (adjustable) radius of curvature determines the focal length.

According to the present invention, a fluid, such as a liquid is filled in a tubular housing with an internal surface including feature(s) that constrain the fluid and thereby present a fluid interface or meniscus, e.g., liquid-liquid or liquid-gas interface. In one aspect, the inner surface of the tubular housing includes adjacent hydrophilic and hydrophobic areas or regions, wherein the boundary between the hydrophobic and hydrophilic regions constrains the fluid and presents a meniscus having a curvature defined, in part, by the static contact angle of the fluid at the boundary. By shifting the fluid interface across the hydrophilic-hydrophobic boundary, the curvature of the spherical interface varies as the contact angle of the fluid changes at the boundary. In one aspect, the shift is effected by application of control pressure to the fluid, or by addition of more fluid (e.g., liquid) into the cavity which forms the fluid lens.

According to one aspect of the present invention, an optical device is provided that typically includes a tubular housing having an inner surface, a hydrophobic surface, a hydrophilic surface, and a first fluid disposed within the tubular housing in contact with the hydrophilic surface, wherein a boundary between the hydrophilic and hydrophobic surface constrains the fluid and presents a meniscus. The optical device also typically includes a pressure or volume control means fluidly coupled with the fluid for adjusting the pressure of the fluid and therefore also the curvature of the meniscus.

According to another aspect of the present invention, an optical device is provided that typically includes a tubular housing having an inner surface, a hydrophilic surface disposed on said inner surface, a fluid disposed within the tubular housing in contact with the hydrophilic surface, wherein a boundary feature constrains the fluid and presents a meniscus. The optical device also typically includes a pressure or volume control means coupled with the fluid for adjusting the curvature of the meniscus.

According to a different aspect of the present invention, a method of adjusting the curvature of a fluid meniscus is provided. The method typically includes providing a fluid within a tubular housing having a hydrophilic and hydrophobic surface, wherein a meniscus of the fluid is constrained at a boundary between the hydrophilic and hydrophobic surfaces and adjusting a pressure applied to the fluid to change the curvature of the meniscus.

According to yet another aspect of the present invention, a method of adjusting the curvature of a fluid meniscus is provided. The method typically includes providing a fluid within a tubular housing having a hydrophilic or a hydrophobic surface, wherein a boundary feature constrains the fluid and presents a meniscus, and adjusting a pressure applied to the fluid to change the curvature of the meniscus.

According to a further aspect of the present invention, a use of the optical device in an apparatus selected from the group consisting of a mini camera, an optical switch, a portable microscope, a CD or DVD drivers, a barcode readers and an endoscope is provided.

According to an additional aspect of the present invention, a use of the optical device in fiber optics coupling, detection and microsurgery applications is provided.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 illustrates an adjustable focus fluid lens according to the present invention. Dynamic focus of the fluid interface, e.g., liquid-liquid or liquid-gas interface, is achieved by shifting the contact angle of the fluid interface at a boundary defined by different surface energy features, such as a boundary defined by a hydrophobic and hydrophilic areas, as shown in FIGS. 1a-1c.

FIG. 2 illustrates images of an adjustable focus fluid lens having a liquid-liquid interface, e.g., water-polyphenylmethylsiloxane interface, at a boundary of hydrophobic Teflon and hydrophilic glass. Variation of the radius of curvature of the interface is achieved by changing the pressure applied to the liquid.

FIG. 3 illustrates an adjustable focus fluid lens system having at least one solid lens in a variable sized tubular housing.

FIG. 4 illustrates an adjustable focus fluid lens system having at least one solid lens in contact with two liquid lens in a variable sized tubular housing.

FIG. 5 presents a schematic showing a liquid film on the window enclosing window of a lens housing.

FIG. 6 illustrates images of adjustable focus liquid lens having a water film on the enclosing window of a lens housing.

### DETAILED DESCRIPTION OF THE INVENTION

The present invention provides a variable focus fluid lens wherein the focal length is controllable by changing the contact angle of a fluid meniscus.

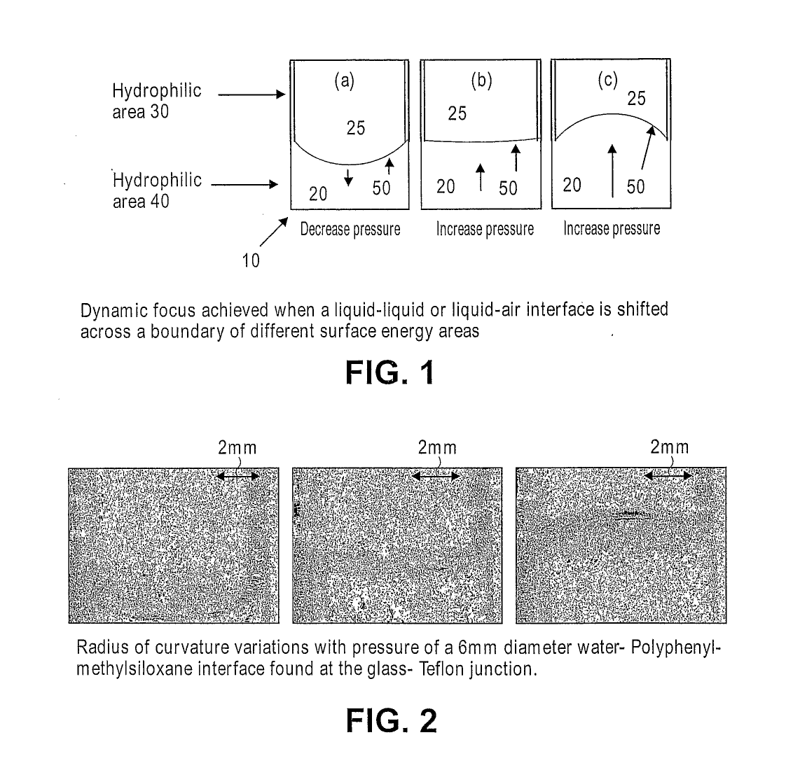

FIG. 1 illustrates an optical device having an adjustable focus fluid lens according to one embodiment of the present invention. As shown, a tubular housing 10 includes a hydrophobic region 30 adjacent a hydrophilic region 40. A first fluid 20, such as water, is contained within tubular housing 10. As shown, the fluid 20 is constrained at the boundary between the hydrophobic region 30 and the hydrophilic region 40 due to the hydrophobic properties of region 30. A second fluid 25 further constrains the fluid 20, and a fluid-fluid interface, or meniscus, 50 is formed. Second fluid 25 may include a gas or a second liquid that is immiscible with the first fluid 20. The contact angle of the fluid-fluid interface 50 defines the curvature of the meniscus 50, which in turn defines the focal length of the fluid lens.

The schematic shown in FIG. 1 below also illustrates a methodology for adjusting the curvature, and thereby the focus, of the liquid lens according to one embodiment. As shown, a hydrophilic high surface tension fluid like water is filled in to the hydrophilic area exactly to the boundary with the hydrophobic area. In FIG. 1a, the contact angle of the meniscus 50 at this stage is concave. By applying pressure to the fluid (FIG. 1b), the curvature of the meniscus decreases (the radius of curvature increases). By increasing the pressure further (FIG. 1c), the meniscus pushes into the hydrophobic area and the contact angle becomes convex.

Accordingly, the curvature of the lens formed by the fluid meniscus can be tuned. In general, the curvature of the meniscus will have a tunability range between the static contact angle of the fluid, e.g., water, with the hydrophilic surface and the static contact angle of the fluid, e.g., water, with the hydrophobic surface.

Dynamic focus is achieved in the same manner using the meniscus of a liquid-liquid interface of two immiscible liquids. FIG. 2 shows images of the lensing effect obtained with a water-silicon oil interface. The prototype was fabricated using a glass tube (hydrophilic layer) and a Teflon coating as the hydrophobic layer. Curvature of the lens can be adjusted by variation of the pressure applied to the liquid.

One advantage of using a two liquid interface is that evaporation of the fluid, e.g., water, forming the lens is avoided. However, the choice of liquids requires a careful design to match suitable liquid densities, and refractive index. For example, in certain aspects it is preferable that the liquids have the same, or similar densities, and that the liquids have unequal indexes of refraction. In some other aspects, the two liquids may have the same or similar densities, and similar indexes of refraction; or the two liquids may have different densities, and similar indexes of refraction; or the two liquids may have different densities, and different indexes of refraction.

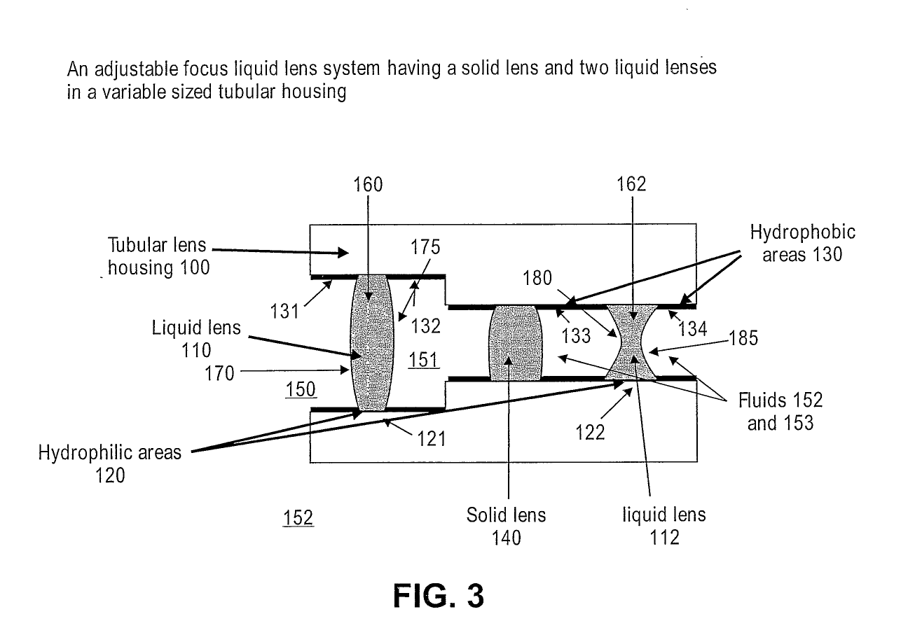

FIG. 3 illustrates an optical device including a variable focus fluid lens according to one embodiment of the present invention. As shown, the device has a tubular housing 100 with two different sized internal cross-sections as shown. It should be apparent to a person of skill in the art that tubular housings having other various shapes and dimensions can also be used in the present invention. The housing 100 has an internal surface, which is divided into several hydrophobic areas 131-134 and hydrophilic areas 121 and 122. The device shown has one solid lens 140 and two liquid lenses 110 and 112. The liquid lenses 110 and 112 are in contact with hydrophilic areas 121 and 122, respectively. The liquid 160 and liquid 162 in each liquid lens can be the same or similar or completely different liquids. As shown in FIG. 3, fluid 150 is in contact with one side of the liquid lens 110 to form one fluid-liquid interface 170. Similarly, fluid 151 is in contact with the other side of liquid lens 110 to form another fluid-liquid interface 175. Likewise, fluid 152 is in contact with one side of liquid lens 112 to form one fluid-liquid interface 180 and fluid 153 is in contact with the other side of liquid lens 112 to form another fluid-liquid interface 185. Alternative, liquid lenses 110 and/or 112 are not in contact with another fluid. FIG. 3 shows one embodiment of the present invention where solid lens 140 is situated between two liquid lenses. One skilled in the art will understand that other positions and arrangements of liquid and solid lenses within a tubular housing are feasible. One or more pressure ports (not shown) are provided in the tubular housing 100 to allow for adjustment of pressure of fluids contained within housing 100 so as to adjust the curvature of the various fluid-fluid interfaces.

In some aspects of the present invention, at least one liquid lens may be situated between solid lenses. The two interfaces of a liquid lens may be both convex, both concave, or one convex and the other concave. As shown in FIG. 3, liquid 160 and liquid 162 in lenses 110 and 112 may be the same or similar liquids or different liquids. In one embodiment of the present invention, liquid lenses 110 and 112 are in contact with the hydrophilic surfaces 121 and 122, respectively. Alternatively, the liquid lens may be in contact with hydrophobic surfaces.

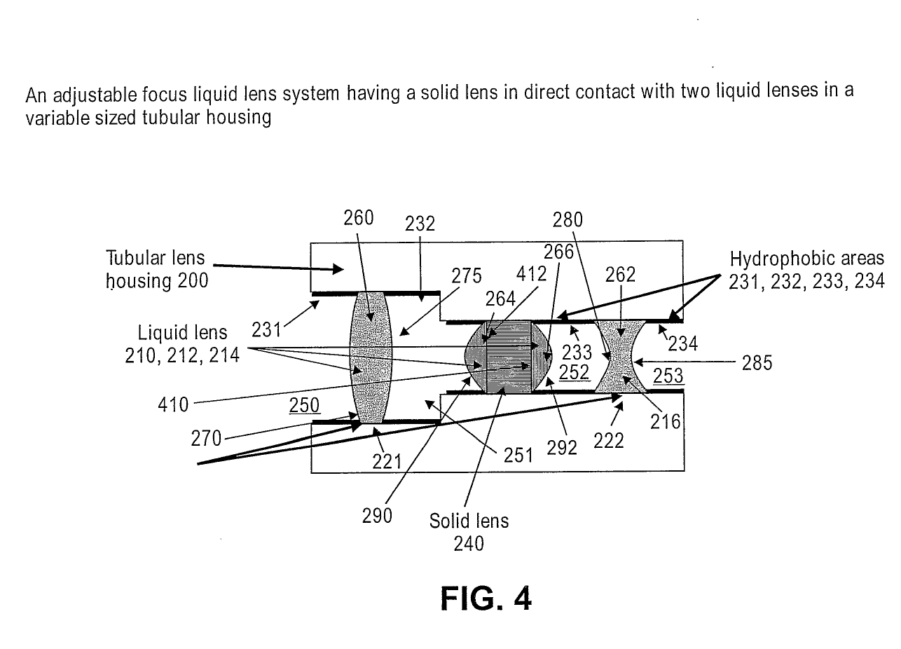

FIG. 4 illustrates another optical device including multiple variable focus fluid lenses according to one embodiment of the present invention. As shown, the device has a tubular housing 200 with two different sized internal cross-sections. It should be apparent to a person of skill in the art that tubular housings having other various shapes and dimensions can also be used in the present invention. The housing 200 has an internal surface, which is divided into several hydrophobic regions 231-234 and hydrophilic regions 221 and 222. The device shown also has one solid lens 240 in contact with two fluid lenses 212 and 214 and two additional fluid lenses 210 and 216 located on each side of the solid lens 240 as shown. The fluid lenses 210 and 216 are proximal the interface between a hydrophobic region and hydrophilic regions 221 and 222, respectively. The fluids 260, 262, 264 and 266 forming each liquid lens can be the same or similar or completely different fluids (e.g., liquids). As shown in FIG. 4, fluid 250 is in contact with one side of the fluid lens 210 to form one fluid-fluid interface 270. Similarly, fluid 251 is in contact with the other side of fluid lens 210 to form another fluid-fluid interface 275. Likewise, fluid 252 is in contact with one side of fluid lens 216 to form one fluid-fluid interface 280 and fluid 253 is in contact with the other side of fluid lens 216 to form another fluid-fluid interface 285. Also, fluid 251 is in contact with fluid lens 212 to form one fluid-fluid interface 290 and fluid 252 is in contact with fluid lens 214 to form another fluid-fluid interface 292. Furthermore, fluid lenses 212 and 214 are in contact with solid lens 240 to form solid-fluid interfaces 410 and 412, respectively. Alternatively, liquid lenses 210 and/or 216 are not in contact with another fluid. One skilled in the art will understand that other positions, numbers and arrangements of fluid and solid lenses within a tubular housing are feasible. One or more pressure ports (not shown) are provided in tubular housing 200 to allow for adjustment of pressure of fluids contained within housing 200 so as to adjust the curvature of the various fluid-fluid interfaces.

In some aspects of the present invention, at least one liquid lens may be situated between solid lenses. The two interfaces of a liquid lens may be both convex, both concave, or one convex and the other concave. As shown in FIG. 4, liquid 260, 262, 264 and 266 in lenses 210, 216, 212 and 214, respectively may be the same or similar liquid or different liquids. In one embodiment of the present invention, liquid lenses 210 and 216 are in contact with the hydrophilic surfaces 221 and 222, respectively. Alternatively, the liquid lens may be in contact with hydrophobic surfaces.

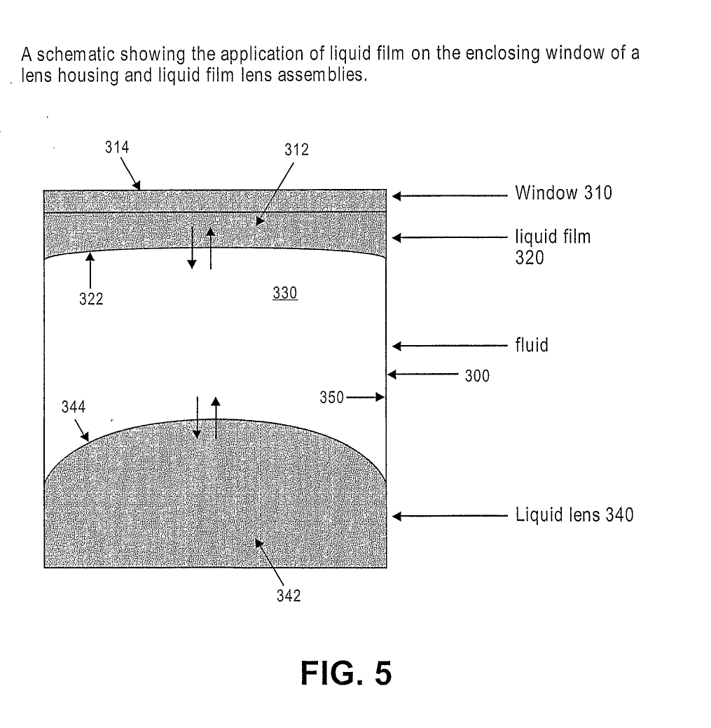

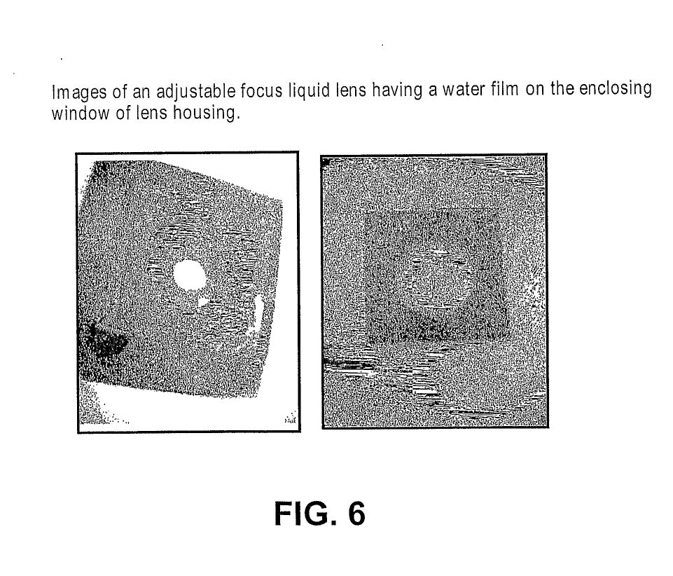

FIG. 5 is a schematic showing the application of a liquid film on the enclosing window of a lens housing. As shown, the device has a tubular housing 300. The housing 300 has a window 310, an inner surface 350 configured to hold and constrain fluids 330 and 342 to form a liquid lens 340. The window 310 can be made of hydrophobic or hydrophilic materials, such as a glass or a plastic. The window has an inner surface 312 and an outer surface 314. The inner surface 312 may be coated with a hydrophilic or hydrophobic material. In one aspect, the window is coated with or is in contact with a thin liquid 320 as shown. The thin liquid 320 has a surface 322, which is in further contact with fluid 330. The fluid 330 may be a gas, such as air, oxygen, nitrogen, hydrogen, carbon dioxide, carbon monoxide or a noble gas; or a liquid, such as a hydrocarbon solvent, an oil or the vapor of liquid 320. The inner surface 350 of the housing may be a hydrophilic or a hydrophobic surface. The liquid lens 340 is in contact with the inner surface 320 of the housing and has a surface 344 in contact with fluid 330. The liquid 342 may be the same as liquid 320 or different from liquid 320. FIG. 5 shows one embodiment of the present invention where the window 310 is a glass window. Liquid 320 and 342 are water in equilibrium, and the fluid 330 is air. The inner surface 350 is a hydrophobic material. One skilled in the art will understand that other fluids, liquids and inner surface coating materials are feasible for use in devices of the present invention.

A hydrophobic surface may be made from a fluorinated polymer, such as Teflon (polytetrafluoroethylene), CYTOP (an amorphous perfluoropolymer obtained by copolymerization of perfluoro(alkenyl vinyl ethers)) or perfluoroalkyltrichlorosilanes, e.g., like 1H, 1H, 2H, 2H-Perfluorodecyltrichlorosilane or alkyltrichlorosilane such as OTS octadecyltrichlorosilane. A hydrophilic surface is generally made of glass or fused silica, other materials such ceramic or hydrophilic metals or hydrophilic polymers for example, hydroxylic polyacrylate or polymethacrylate, polyacrylamides, cellulosics polymers, polyvinyl alcohols. Coatings of these materials can also be used. In one embodiment, the hydrophobic surface is in contact with the hydrophilic surface.

In one aspect of the present invention, the hydrophobic surfaces of a device, e.g., surfaces 131-134, include the same or similar types of materials. Alternatively, hydrophobic surfaces of a device, e.g., surfaces 131-134, include different types of materials.

As above, in one aspect, a tubular housing of the present invention has a hydrophobic and a hydrophilic region on the inner surface of the tubular housing. Alternatively, or additionally the tubular housing may include a hydrophilic or a hydrophobic inner surface and a boundary feature, which functions to constrain the fluid. The boundary feature can be a nanoscopic microstructure or a structure protruding or extending within the inner surface of the tubular housing. The structures can typically be formed using injection moulding techniques or imprinting or lithography techniques, such as nano-imprinting or nano-lithography, as are well known in the art.

The boundary feature of the present invention may be a structure in contact with the inner surface of the tubular housing, such as a ring of material disposed on the inner surface of the tubular housing. The boundary feature structure may be composed of nano- or micro-structures having the same or different materials than the housing, such as polymer, inorganic, metal, or ceramic materials or hybrids thereof.

The tubular housings used in the present invention may have variable shapes and dimensions. In one embodiment, a tubular housing has a symmetrical cross-section and in another embodiment, a tubular housing has an unsymmetrical cross-section. In yet another embodiment, a tubular housing may have a continuous or a discrete variation of the size of the cross-section along the tubular housing, e.g., as shown in FIGS. 3 and 4. Portions of a tubular housing used in the present invention may have elliptical, circular and/or polygonal cross-sections. The number of sides of the polygonal cross-section may vary from 3 to about 16. One example is a four-sided polygon such as a square or rectangle.

Various types of fluids may be used within a tubular housing. A fluid disposed in a tubular housing can be either liquid or gas. The fluid may be a polar, combined with a non-polar, liquid or gas. Examples of useful polar liquids include water, polyhydric alcohols such as glycerol, 1,2-propanediol, ethylene glycol and the like. Examples of useful non-polar liquids include silicon oil or hydrocarbons such as 1-bromododecane, butyl benzyl phthalate, benzyl alcohol. Example of a suitable gas is air. In one embodiment, the fluid is in contact with the hydrophilic region of the inner surface. Alternatively, the fluid may be in contact with the hydrophobic region of the inner surface. The fluid in the housing may be in contact with another fluid or alternatively has no contact with any other fluid. The fluid may be constrained by a physical boundary feature or by the boundary formed between the hydrophilic and hydrophobic surfaces to form a fluid-fluid interface or meniscus.

In one aspect of the invention, the first fluid in the tubular housing may be in contact with at least one second fluid. The second fluid may be immiscible with the first fluid or partially soluble with the first fluid. Any combination of polar and non polar fluids and polar fluids with gas from the examples given above are suitable. In a different aspect of the invention, the tubular housing only contains one fluid.

The fluid interface presents a meniscus at the boundary, e.g., a hydrophilic-hydrophobic boundary or a physical boundary feature. The curvature or radius of curvature (reciprocal of curvature) of the meniscus and the contact angle can be adjusted by applying a pressure to the fluid. The curvature of a plane curve is defined by the equation (x′y″−y′x″)/(x′²+y′²)^{3/2}, where x′, x″, y′ and y″ are the first and the second derivatives. As shown in FIG. 1, the curvature of the meniscus can be tuned by increasing or decreasing the pressure applied to the fluid. The curvature has opposite signs in FIG. 1(a) and FIG. 1(c). The curvature of the meniscus in FIG. 1(b) is zero. The tunability range of the curvature is from the static contact angle of a fluid on a hydrophilic or hydrophobic surface to the contact angle of the fluid on a hydrophobic or hydrophilic surface.

In a preferred embodiment, changing the pressure is effected using a pressure generating device and/or a device that alters the volume of fluid in a cavity. For example, in one aspect, the pressure applied to the fluid is an electrokinetic pressure generated by, for example, electroosmosis, a ratchet pump, or electrowetting. In another embodiment, fluid pressure is generated using pneumatic or magnetohydrodynamic pumps. In yet another embodiment, the pressure applied to the fluid is generated by a mechanical device. One example of a useful mechanical pressure generating device is a screw-type pumping device or a peristaltic pump.

The present invention also provides a method of adjusting the curvature of a fluid meniscus. The method typically includes providing a fluid within a tubular housing having a hydrophilic and hydrophobic surface, wherein a meniscus of the fluid is constrained at a boundary between the hydrophilic and hydrophobic surfaces, and adjusting a pressure applied to the fluid to change the curvature of the meniscus. In one embodiment, the tubular housing is provided with a fluid inside. In another embodiment, the tubular housing is provided with a hydrophilic and a hydrophobic surface. In yet another embodiment, the tubular housing is provided and a hydrophilic and optionally a hydrophobic surface are formed afterwards. The pressure generating device may contact to the fluid directly or through a medium. A preferred pressure generating apparatus is an electroosmotic assembly.

The present invention further provides a method for adjusting the curvature of a fluid meniscus. The method typically includes providing a fluid within a tubular housing having a hydrophilic surface and wherein a boundary feature constrains the fluid and presents a meniscus, and adjusting a pressure applied to the fluid to change the curvature of the meniscus. In one embodiment, the tubular housing is provided with a fluid inside. In another embodiment, the tubular housing is provided with a hydrophilic and a hydrophobic surface. In yet another embodiment, the tubular housing is provided and a hydrophilic and optionally a hydrophobic surface are added afterwards. The pressure generating device may contact to the fluid directly or through a medium. A preferred pressure generating apparatus is an electroosmotic assembly.

The liquid lenses described in the present invention advantageously provide very low cost, compact optical focusing systems ideal for portable imaging devices.

In another aspect, the present invention provides a use of the optical device in an apparatus selected from the group consisting of a mini camera, an optical switch, a portable microscope, a CD or DVD device, a barcode reader and an endoscope. For example, lenses according to the present invention can be employed as components in optical devices used in telecommunications (e.g., minicameras, optical switches), data storage (e.g., CD, DVD type of drivers, barcode readers), sensing (e.g., analytical equipment), manufacturing (e.g., laser technology) and medicinal (e.g., endoscopes) applications. In particular, the present invention is useful in the fabrication of mobile phone cameras and digital cameras.

In yet another aspect, the present invention provides a use of the optical device in fiber optics coupling, detection and microsurgery applications. The variable focus lens described in the present invention is particularly suitable for the use in phone cameras.

In preferred aspects, a fluid channel is formed in a silicon substrate housing standard photolithography techniques. Other useful substrate materials include an insulated metal, a insulated non-metal, an insulated semiconductor and an insulator. Specific examples include silicon, silicon nitride, quartz, glass and others. It should be appreciated that other materials as would be apparent to one skilled in the art may be used. A fluid channel according to the present invention preferably has a circular cross-section as shown, for example in FIG. 1. However, it should be appreciated that a fluid channel may have any cross-sectional geometry such as, for example, oval or elliptical, square, rectangular, triangular, hexagonal, etc. Further, the fluid channel, in certain aspects should have dimensions suitable for the particular application. For example, in one circular cross-section embodiment, the fluid channel (and thus the diameter of a fluid lens) has a diameter of between about 1000 or 100 μm or less. It should be appreciated that the diameter (or relevant dimension of other cross sectional geometry channels) can range down to the limits of photolithograpy processing (e.g., currently on the order of 100 nm) up to the mm or cm range.

One example of a process to form a device structure, e.g., fluid channel in a substrate (housing) according to the present invention will now be described. In one aspect, standard silicon/glass microfabrication technologies are used to fabricate a fluid channel in a housing. First, silicon and glass wafers are cleaned using standard cleaning techniques. For a fluid channel, a photoresist is spin coated on the silicon wafer, then exposed with a photomask containing the fluid channel pattern. After developing, the fluid channel pattern is transferred to the photoresist. Etching, e.g., BHF etching, is used to remove SiO₂ on the patterned area. Thereafter, using wet etching (e.g., KOH, 40%+60° C.) or other etching technique, the channel is etched to the desired depth, e.g., to be about 100 μm deep. Hydrophobic material, e.g., CYTOP, may then be patterned and deposited, e.g., spin coated, exposed, developed and etched as is well known. Alternatively, a surface feature structure may be deposited or otherwise formed in the fluid channel in lieu of or in addition to a hydrophobic region. For example, a surface feature such as a ring of material may be formed in the substrate during formation of the fluid channel, e.g., during the patterning, masking and etching stages, or a ring of material may be deposited or otherwise formed after the fluid channel is formed. It should be appreciated that the above is only an example of a possible method to create a fluid channel and that other additional or alternative materials, parameters and process steps may be used as desired.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. An optical device, comprising:
a) a tubular housing having an inner surface, said inner surface having a hydrophobic portion and a hydrophilic portion;
b) a first fluid disposed within the tubular housing in contact with the hydrophilic surface portion, wherein a boundary between the hydrophilic and hydrophobic surface portion constrains the fluid and presents a meniscus; and
c) a pressure control means coupled with the fluid for adjusting the curvature of the meniscus.

2. The device of claim 1, wherein the hydrophobic surface and hydrophilic surface portions are disposed on said inner surface.

3. The device of claim 1, wherein the first fluid is in contact with a second fluid.

4. The device of claim 1, wherein the first fluid is not in contact with a second fluid.

5. The device of claim 3, wherein the second fluid is immiscible with the first fluid.

6. The device of claim 3, wherein the first and/or the second fluid is a dielectric or a conducting fluid.

7. The device of claim 6, wherein the first and/or the second fluid is polar.

8. The device of claim 3, wherein the second fluid is immiscible with the first fluid, and is selected from the group consisting of a gas, a liquid and a combination thereof.

9. The device of claim 1, wherein the tubular housing has a symmetrical cross-section or an unsymmetrical cross-section.

10. The device of claim 9, wherein the shape and/or dimension of the symmetrical and/or unsymmetrical cross-section varies at different locations of the tubular housing.

11. The device of claim 9, wherein the symmetrical cross-section is a member selected from the group consisting of an elliptical, a circular and a polygonal cross-section, and wherein the number of sides of the polygonal cross-section is from 3 to 16.

12. The device of claim 1, wherein the fluid is selected from the group consisting of a gas, a liquid and a combination thereof.

13. The device of claim 1, wherein the hydrophilic surface portion includes a material selected from the group consisting of glass, fused silica, ceramic, hydrophilic metal and hydrophilic polymer materials.

14. The device of claim 1, wherein the hydrophobic surface includes a material selected from the group consisting of a polymer and a small organic molecule.

15. The device of claim 14, wherein the polymer is selected from the group consisting of Teflon, CYTOP and perfluoroalkyltrichlorosilanes.

16. The device of claim 1, wherein the pressure or volume control means includes an electrokinetic or a mechanical pressure or volume control assembly selected from the group consisting of a screw-type pumping device and a peristaltic pump.

17. The device of claim 1, further comprising at least one solid lens within the tubular housing.

18. An optical device, comprising:
a) a tubular housing having an inner surface;
b) a hydrophilic or a hydrophobic surface disposed on said inner surface;
c) a fluid disposed within the tubular housing in contact with the hydrophilic or hydrophobic surface and wherein a boundary feature constrains the fluid and presents a meniscus; and
d) a pressure or volume control means coupled with the fluid for adjusting the curvature of the meniscus.

19. The device of claim 18, wherein the boundary feature is a structure in contact with the inner surface of the tubular housing.

20. The device of 18, wherein the boundary feature includes a ring of material disposed on the inner surface.

21. A method of adjusting the curvature of a fluid meniscus, comprising:
a) providing a fluid within a tubular housing having hydrophilic and hydrophobic surface portions, wherein a meniscus of the fluid is constrained at a boundary between the hydrophilic and hydrophobic surface portions; and
b) adjusting a pressure applied to the fluid, or a volume of the fluid within the housing, to change the curvature of the meniscus.

22. The method of claim 21, wherein the hydrophobic surface and hydrophilic surface portions are disposed on said inner surface.

23. The method of claim 21, wherein the fluid is in contact with at least one other fluid.

24. The method of claim 21, wherein the fluid is not in contact with any other fluid.

25. The method of claim 23, wherein the fluids are immiscible with each other.

26. The method of claim 21, wherein the fluid is a dielectric or a conducting fluid.

27. The method of claim 26, wherein the fluid is polar.

28. The method of claim 21, wherein the fluid is selected from the group consisting of a gas, a liquid and a combination thereof.

29. The method of claim 21, wherein the tubular housing has a symmetrical cross-section or an unsymmetrical cross-section.

30. The method of claim 21, wherein the tubular housing has a variable sized cross-section.

31. The method of claim 29, wherein the symmetrical cross-section is a member selected from the group consisting of a circular and a polygonal cross-section and wherein the number of sides of the polygonal cross-section is from 3 to 16.

32. A method of adjusting the curvature of a fluid meniscus, comprising:
a) providing a fluid within a tubular housing having a hydrophilic or a hydrophobic surface and a boundary feature that constrains the fluid and presents a meniscus; and
b) adjusting a pressure applied to the fluid, or a volume of the fluid within the housing, to change the curvature of the meniscus.

33. The device of claim 32, wherein the boundary feature is a structure in contact with the inner surface of the tubular housing.

34. The device of claim 32, wherein the boundary feature includes a ring of material disposed on the inner surface.

35. A use of the optical device of claim 1 in the manufacture of an apparatus selected from the group consisting of a mini camera, an optical switch, a portable microscope, a CD or DVD device, a barcode reader, an endoscope, a beam steering device or a light beam manipulation device.

36. A use of the optical device of claim 1 in fiber optics coupling, light detection or microsurgery applications.

37. An optical device, comprising:
a) a tubular housing having an inner surface;
b) a solid lens disposed within the tubular housing;
c) a first fluid disposed within the tubular housing in contact with the solid lens;
d) a second fluid disposed within the tubular housing in contact with the first fluid, wherein a boundary between the first and second fluids presents a miniscus; and
e) a pressure or volume control means coupled with the first or the second fluid for adjusting the curvature of the meniscus.

38. The device of claim 37, wherein the second fluid is immiscible with the first fluid.

39. The device of claim 37, wherein the first fluid is a liquid.

40. The device of claim 39, wherein the second fluid is immiscible with the first fluid, and wherein the second fluid is selected from the group consisting of a gas, a liquid and a combination of a gas and a liquid.
